(19) United States
(12) Patent Application Publication
(10) Pub. No.: US 2009/0136609 A1
(43) Pub. Date: May 28, 2009

(54) APPARATUS FOR IN-MOLD-DECORATION MOLDING

(75) Inventors: CHUN-YUAN CHANG, Tu-Cheng (TW); CHUNG-CHI TSENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/965,758

(22) Filed: Dec. 28, 2007

(30) Foreign Application Priority Data
Nov. 23, 2007 (CN) 200710202647.2

(51) Int. Cl. B29C 45/16

(52) U.S. Cl. 425/116

(57) ABSTRACT

An apparatus for an in-mold-decoration molding includes a female mold and a male mold. The female mold has an enclosing portion protruding therefrom. The male mold has a protrusion protruding therefrom. The protrusion is step-shaped and includes a receiving portion and a protruding portion protruding from the receiving portion. The receiving portion is configured for fitting with the enclosing portion and allowing a foil to attach thereto, therefore the male mold and the female mold cooperate to define a molding space with an end thereof being covered by the foil.

### CROSS-REFERENCE TO RELATED APPLICATIONS

Relevant subject matter is disclosed in a co-pending U.S. patent application (Attorney Docket No. US16713) filed on the same date and entitled “APPARATUS AND METHOD FOR IN-MOLD-DECORATION”, which is assigned to the same assignee with this application.

### BACKGROUND

1. Field of the Invention

The present invention generally relates to molding apparatuses. Particularly, the present invention relates to an apparatus for in-mold-decoration molding.

2. Description of Related Art

A common apparatus for In-Mold-Decoration is illustrated in FIG. 1. The apparatus includes a mold 20 defining a cavity (not labeled) therein and a foil 30. The mold 20 includes a male mold 22 and a female mold 24. The male mold 22 and the female mold 24 cooperate to define a molding space 10 therein. The foil 30 is extended in the mold 20 between the male mold 22 and the female mold 24, and is spread on a surface of the cavity. A printed layer 32 is attached to the foil 30 facing the male mold 22. The printed layer 32 is positioned in the molding space 10 for providing decoration for a molded product.

Referring to FIG. 2, the molding space 10 is filled with molten resin to form a molded product 40. The printed layer 32 is attached to a surface of the molded product 40 after the molten resin is cooled, therefore providing decoration for the molded product 40. However, usually not all of the printed layer 32 is attached to the molded product 40, due to the fact that the foil 30 together with the printed layer 32 cannot always be pressed against the entire surface of the molded product 40 to be decorated by the inner surface of the molding space 10, especially the part adjacent to the parting surface of the female mold where a collar of the molded product 40 is formed. Therefore, a part of the printed layer 32 may be still preserved on the foil 30.

### SUMMARY

In one embodiment, an apparatus for an in-mold-decoration molding includes a female mold and a male mold. The female mold has an enclosing portion protruding therefrom. The male mold has a protrusion protruding therefrom. The protrusion is step-shaped and includes a receiving portion and a protruding portion protruding from the receiving portion. The receiving portion is configured for fitting with the enclosing portion and allowing a foil to attach thereto, therefore the male mold and the female mold cooperate to define a molding space with an end thereof being covered by the foil.

Other advantages and novel features of the apparatus and method for in-mold-decoration will become more apparent from the following detailed description of embodiments when taken in conjunction with the accompanying drawings, in which:

### BRIEF DESCRIPTION OF THE DRAWINGS

FIG. 1 is a sectional view of an apparatus for in-mold-decoration molding in a related art;

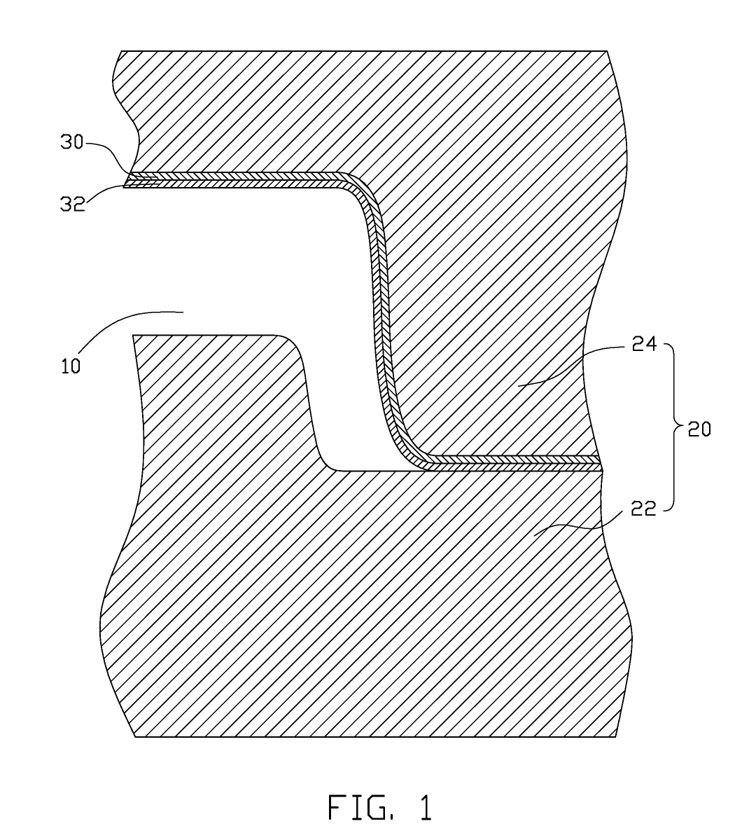

FIG. 2 is a sectional view of the apparatus of FIG. 1 during injection;

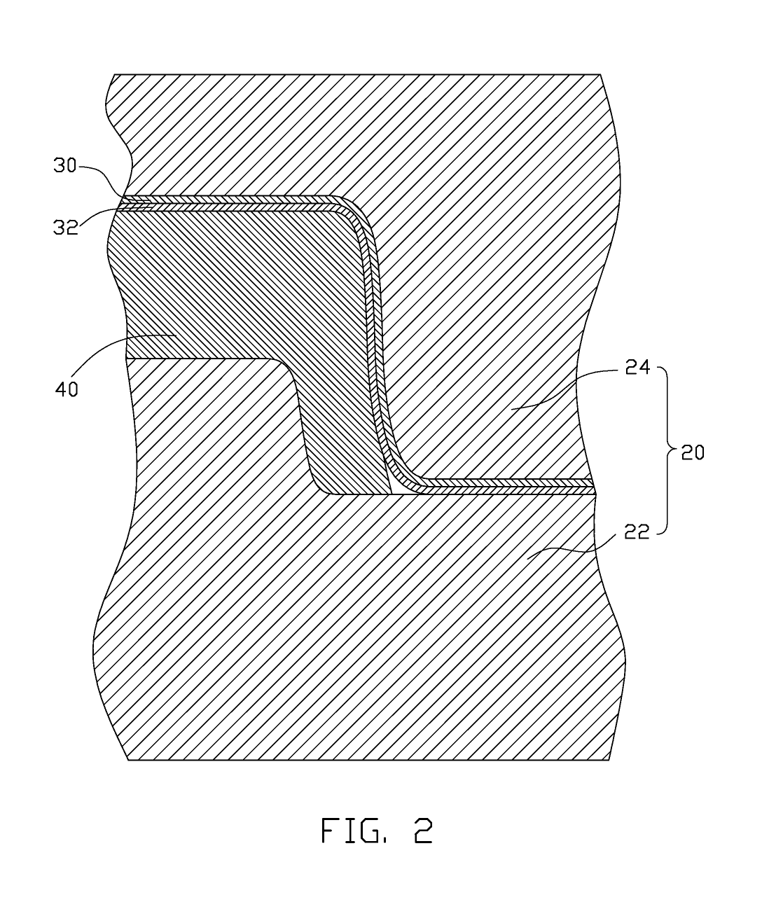

FIG. 3 is a sectional view of an apparatus for in-mold-decoration molding in accordance with an exemplary embodiment; and

FIG. 4 is a sectional view of the apparatus of FIG. 3 during injection.

### DETAILED DESCRIPTION

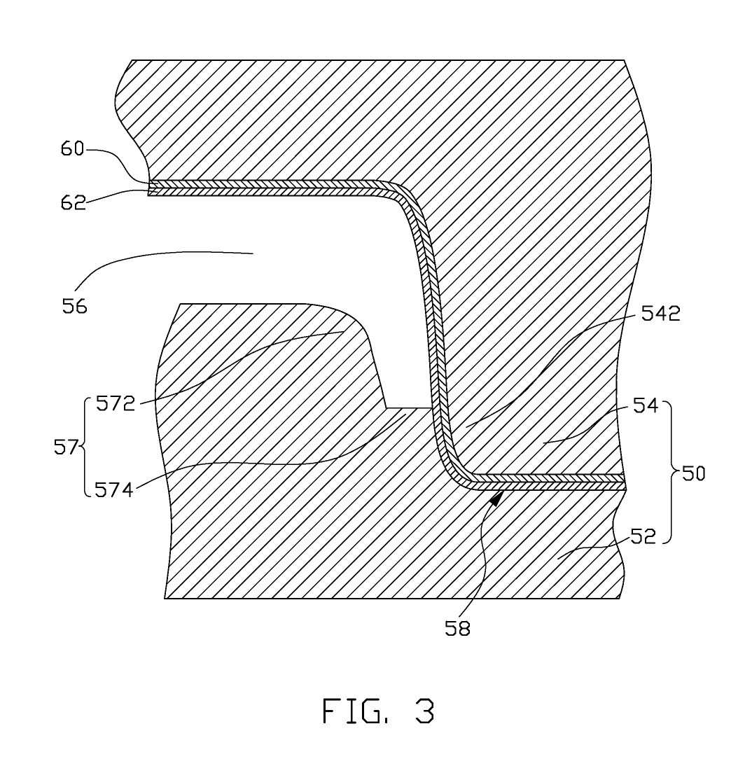

Referring to FIG. 3, an apparatus for in-mold-decoration molding in accordance with an embodiment of the present invention includes a mold 50 and a foil 60.

The mold 50 includes a male mold 52 and a female mold 54. A molding space 56 is defined between the female mold 54 and the male mold 52. The male mold 52 protrudes towards the female mold 54 to form a protrusion 57. The protrusion 57 is generally stepped, which includes a protruding portion 572 and a receiving portion 574. A parting surface 58 is defined on the male mold 52 for resisting against the female mold 54 when the mold 50 is locked. A part of the female mold 54 extends towards the parting surface 58 of the male mold 52 to form an enclosing portion 542. The enclosing portion 542 is used for fitting with a part of the receiving portion 574 of the male mold 52 and tightly resisted against the parting surface 58, therefore the female mold 54 and the male mold 52 cooperatively defining the molding space 56.

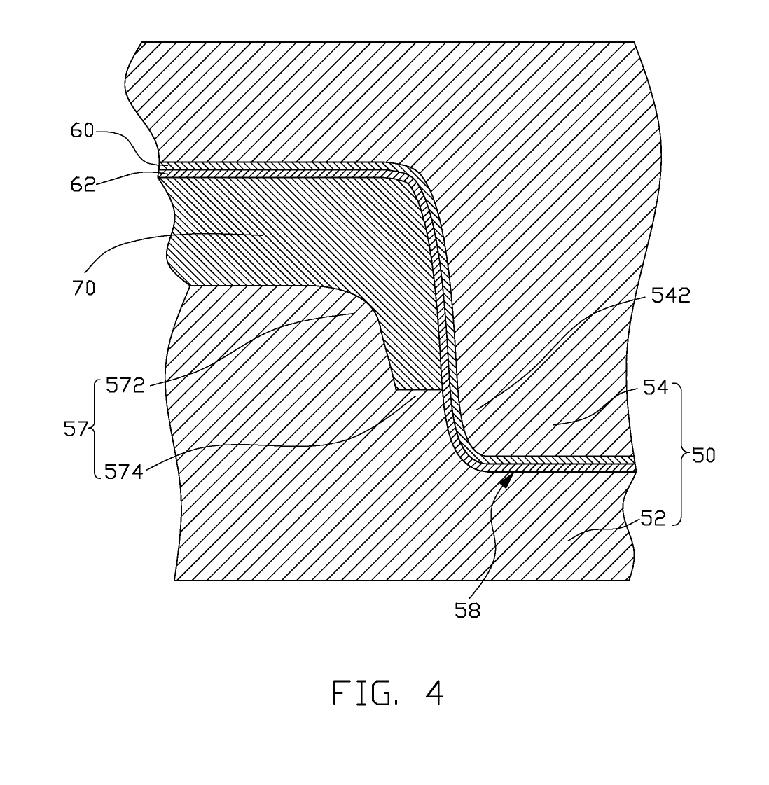

The foil 60 is spread across a portion of the surface of the female mold 54 that cooperates with the male mold 52 to define the molding space 56 where it is desired to transfer a printed layer 62 thereon to a surface of a molded product 40 (as shown in FIG. 4). Further, the foil 60 together with the printed layer 62 is sufficiently large enough in area to extend beyond the desired transfer area to be sandwiched between the female mold 54 and the male mold 52 at the parting surface 58. Because of the stepped nature of the protrusion 57, the joint where the receiving portion 574 meets the enclosing portion 542 allows an accurate sharply defined transition of the foil 60, together with the printed layer 62 from the transfer area to the parting surface 58, thus ensuring full coverage of the transfer area by the printed layer 62.

Referring to FIG. 4, the male mold 52 and the female mold 54 are fit together and the molding space 56 filled with molten resin. After cooling, the resultant molded product 40 is removed and complete transfer of the desired portion of the printed layer 62 is accomplished.

The embodiment was chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiment described therein.

What is claimed is:

1. An apparatus for an in-mold-decoration molding, comprising:
a female mold with an enclosing portion protruding therefrom; and
a male mold with a protrusion protruding therefrom, the protrusion being step-shaped and comprising a receiving portion and a protruding portion protruding from the receiving portion, the receiving portion configured for fitting with the enclosing portion and allowing a foil to attach thereto, therefore the male mold and the female mold cooperate to define a molding space with an end thereof being covered by the foil.

2. The apparatus as described in claim 1, wherein the male mold forms a parting surface facing the enclosing portion for allowing the foil extending from a side surface of the receiving portion of the protrusion to spread thereon.

3. The apparatus as described in claim 2, wherein the enclosing portion presses the foil on a side surface of the receiving portion other from the parting surface.

4. The apparatus as described in claim 1, wherein the protruding portion is used for restricting the molded product together with an end surface around the protruding portion of the receiving portion and a lower part of the inner surface of the molding space.

5. The apparatus as described in claim 1, wherein the female mold, the protruding portion, and a part of the surface of the receiving portion cooperates to define the molding space for allowing the foil to spread therein.

6. An apparatus for in-mold-decoration molding, comprising:
a male mold with a protrusion protruding therefrom; and
a female mold defining a parting surface for resisting the male mold and cooperatively defining a molding space together with the male mold, the molding space configured for allowing molten resin to be injected thereinto, the parting surface exceeding an end of the molding space.

7. The apparatus as described in claim 6, wherein the protrusion is step-shaped and comprises a receiving portion extending from the male mold and a protruding portion protruding from the receiving portion, an end surface around the protruding portion of the receiving portion configured for restricting an end adjacent to the collar of the molded product.

8. The apparatus as described in claim 7, wherein an enclosing portion is protruded from the female mold towards the receiving portion, to be engaged with the receiving portion.

9. The apparatus as described in claim 8, wherein the surface of the receiving portion facing the enclosing portion is configured for pressing a foil to the surface of the enclosing portion.
